(19) United States
(12) Patent Application Publication
(10) Pub. No.: US 2023/0315483 A1
(43) Pub. Date: Oct. 5, 2023

(54) PROCESSOR CORE SUBSYSTEM WITH OPEN-STANDARD NETWORK-ON-CHIP PORTS

(71) Applicants: Shih Jun Chong, Bayan Lepas (MY); Ignacio Celis, Folsom, CA (US); Krishnakumar Ganapathy, Bee Cave, TX (US); Sang Kim, Austin, TX (US); Chuan Yin Loo, Langkawi (MY); Sanjoy K. Mondal, Austin, TX (US); Mukesh Patel, Austin, TX (US); Arvind Raman, Austin, TX (US); Joseph Rowlands, Alviso, CA (US); Shankar Narayanan Venkat Ramani, Austin, TX (US)

(72) Inventors: Shih Jun Chong, Bayan Lepas (MY); Ignacio Celis, Folsom, CA (US); Krishnakumar Ganapathy, Bee Cave, TX (US); Sang Kim, Austin, TX (US); Chuan Yin Loo, Langkawi (MY); Sanjoy K. Mondal, Austin, TX (US); Mukesh Patel, Austin, TX (US); Arvind Raman, Austin, TX (US); Joseph Rowlands, Alviso, CA (US); Shankar Narayanan Venkat Ramani, Austin, TX (US)

(21) Appl. No.: 17/712,106

(22) Filed: Apr. 2, 2022

(51) Int. Cl. G06F 9/4401; G06F 9/48; G06F 9/38; G06F 9/30

(52) U.S. Cl. CPC G06F 9/4405; G06F 9/4887; G06F 9/3877; G06F 9/30123

(57) ABSTRACT

Embodiments of apparatuses, methods, and machine-readable mediums for a subsystem with open-standard network-on-chip ports are disclosed. In an embodiment, a machine-readable medium includes a design of an apparatus to be manufactured, the apparatus to include one or more cores, and a network-on-chip having at least one port of a first type and at least one port of a second type. The first type is to communicate with the one or more cores according to a proprietary protocol. The second type is to communicate with an intellectual property block according to an open-standard protocol.

### FIELD

The field relates generally to electronic products, and, more specifically, but without limitation, to system-on-chip design for electronic products.

### BACKGROUND

An electronic product may include a system-on-chip (SoC) designed using intellectual property (IP) blocks.

### BRIEF DESCRIPTION OF THE DRAWINGS

Embodiments are illustrated by way of example and not limitation in the figures of the accompanying drawings, in which like references indicate similar elements and in which:

FIG. 1A is a block diagram of a processor core subsystem design according to embodiments;

FIG. 1B is a block diagram of a bootable processor core subsystem design according to embodiments;

FIG. 2 is a diagram of a system-on-chip (SoC) design according to embodiments;

FIG. 3 is a flow diagram of a method for testing an SoC design according to embodiments;

FIG. 4A is a block diagram illustrating both an in-order pipeline and a register renaming, out-of-order issue/execution pipeline according to embodiments;

FIG. 4B is a block diagram illustrating both an in-order architecture core and a register renaming, out-of-order issue/execution architecture core to be included in a processor according to embodiments;

FIG. 5 is a block diagram of a processor that may have more than one core, may have an integrated memory controller, and may have integrated graphics according to embodiments;

FIG. 6 is a block diagram of a system according to embodiments;

FIG. 7 is a block diagram of a first more specific system according to embodiments;

FIG. 8 is a block diagram of a second more specific system according to embodiments; and

FIG. 9 is a block diagram of a system-on-a-chip according to embodiments.

### DETAILED DESCRIPTION

In the following description, numerous specific details, such as component and system configurations, may be set forth in order to provide a more thorough understanding of the description. It will be appreciated, however, by one skilled in the art, that embodiments may be practiced without such specific details. Additionally, some well-known structures, circuits, and other features have not been shown in detail, to avoid unnecessarily obscuring the description.

References to “one embodiment,” “an embodiment,” “example embodiment,” “various embodiments,” etc., indicate that the embodiment(s) described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicates that a particular instance of an element or different instances of like elements are being referred to, and is not intended to imply that the elements so described must be in a particular sequence, either temporally, spatially, in ranking, or in any other manner. Also, as used in descriptions of embodiments, a “/” character between terms may mean that an embodiment may include or be implemented using, with, and/or according to the first term and/or the second term (and/or any other additional terms).

As mentioned in the background section, an electronic product may include a system-on-chip (SoC) designed using intellectual property (IP) blocks. Embodiments may be desired because they provide for a particular instruction set architecture (ISA) based (e.g., including one or more processor cores, execution cores, processors, central processing units (CPUs) supporting the particular instruction set) SoC to be designed, by a customer of a particular ISA-based subsystem (as described below) vendor, to include IP blocks intended to be connected to an open-standard bus or interconnect (e.g., Advanced Microcontroller Bus Architecture (AMBA)), without the customer performing a re-design or adding a converter or translator (e.g., to convert/translate between AMBA and the vendor's interconnect, any of which may be expensive, add design time, and/or decrease performance. Therefore, a customer may efficiently design a particular ISA-based SoC using their own IP blocks, third-party IP blocks, and/or a combination of their own and third-party IP blocks.

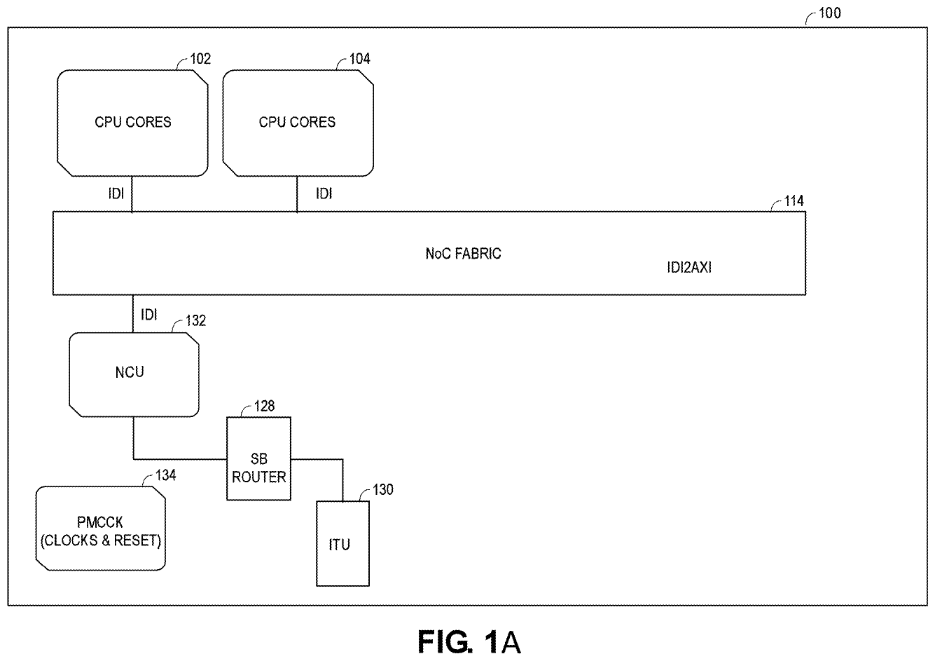

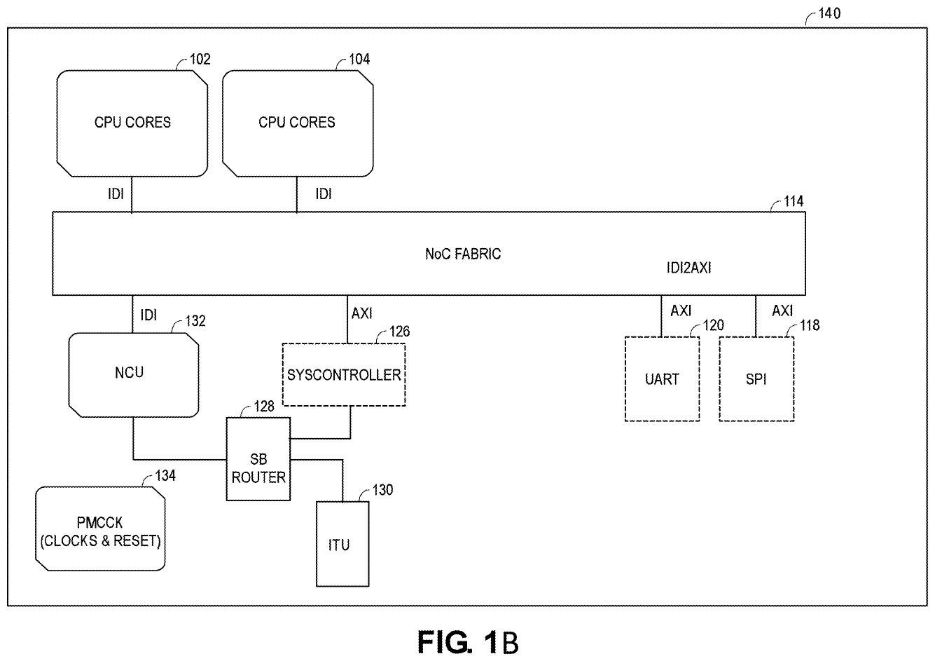

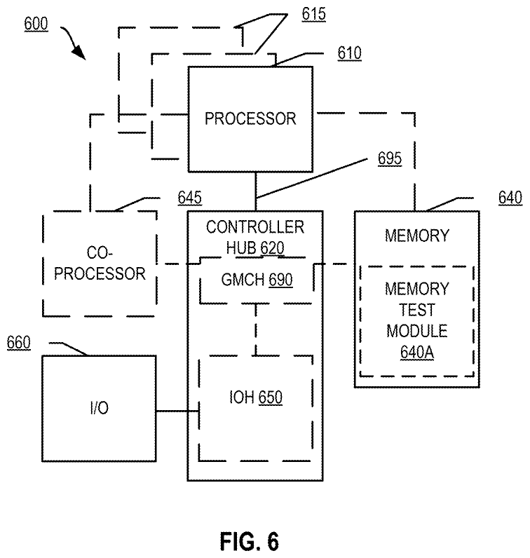

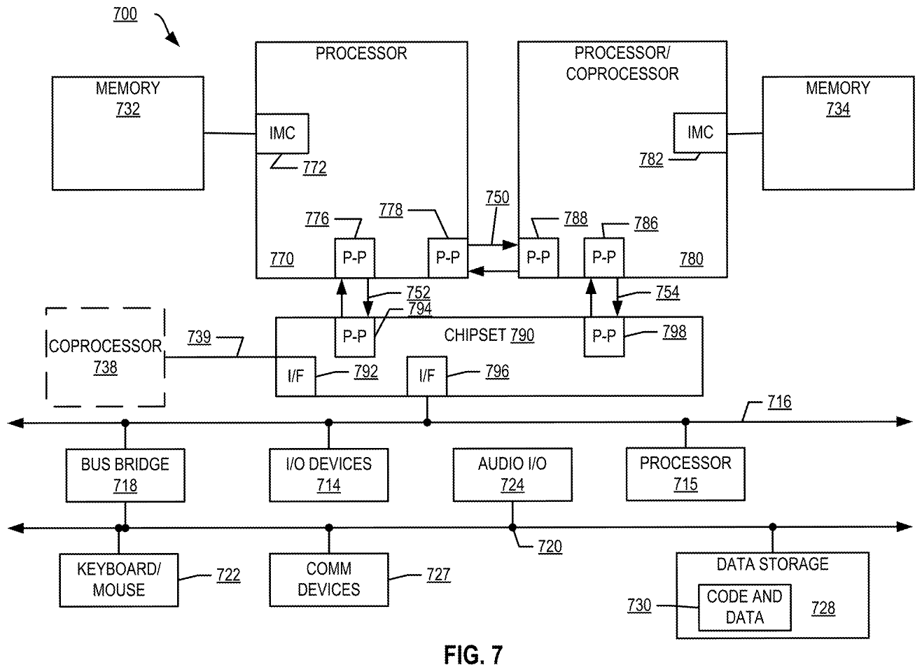

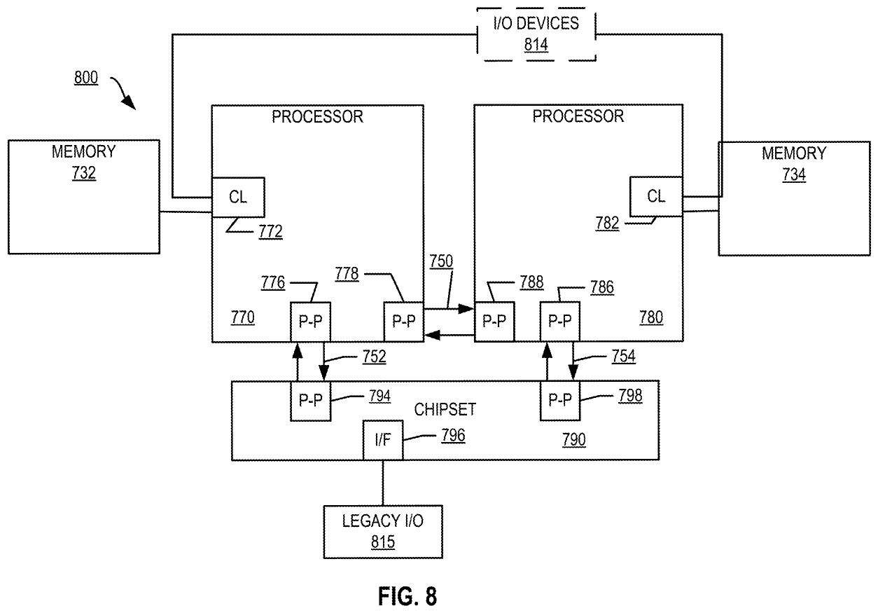

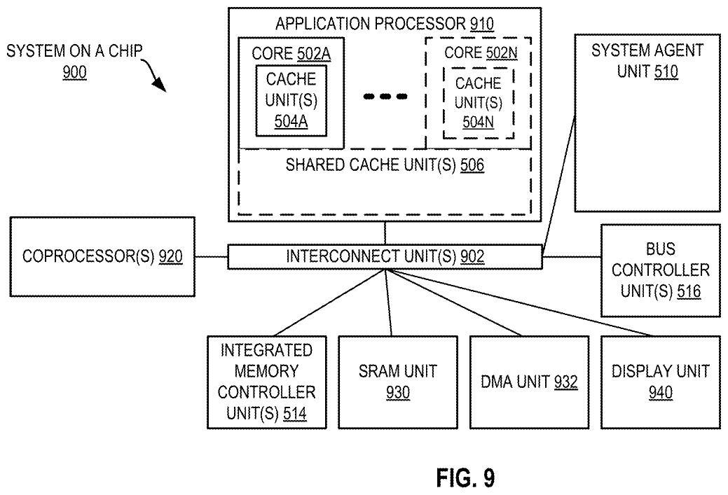

FIG. 1A is a block diagram of a particular ISA (e.g., x86) based subsystem design 100 according to embodiments. Subsystem design 100 may represent the design (e.g., a register-transfer level (RTL) design) or description (e.g., in a hardware description language (HDL)) of a subsystem, stored on a machine-readable medium such that it may be provided to a customer or other third-party as a basis for designing an SoC and/or for integrating into or otherwise including in an integrated circuit (IC), electronic system, or other product, such as system 600 in FIG. 6, system 700 in FIG. 7, system 800 in FIG. 8, or SoC 900 in FIG. 9. Alternatively, subsystem design 100 as shown in FIG. 1A may represent a subsystem as implemented, fabricated, etc. in hardware (e.g., logic gates memory cells, and/or other circuitry), or in any other physical or tangible form, whether as part of a system or otherwise. Therefore, the following descriptions of blocks shown in the block diagram may correspond to designs (e.g., RTL), descriptions (e.g., HDL), circuitry, etc. of such blocks, and subsystem design 100 may be referred to and/or represent a particular ISA (e.g., x86) based subsystem design, a particular ISA (e.g., x86) based subsystem, a subsystem design, and/or a subsystem.

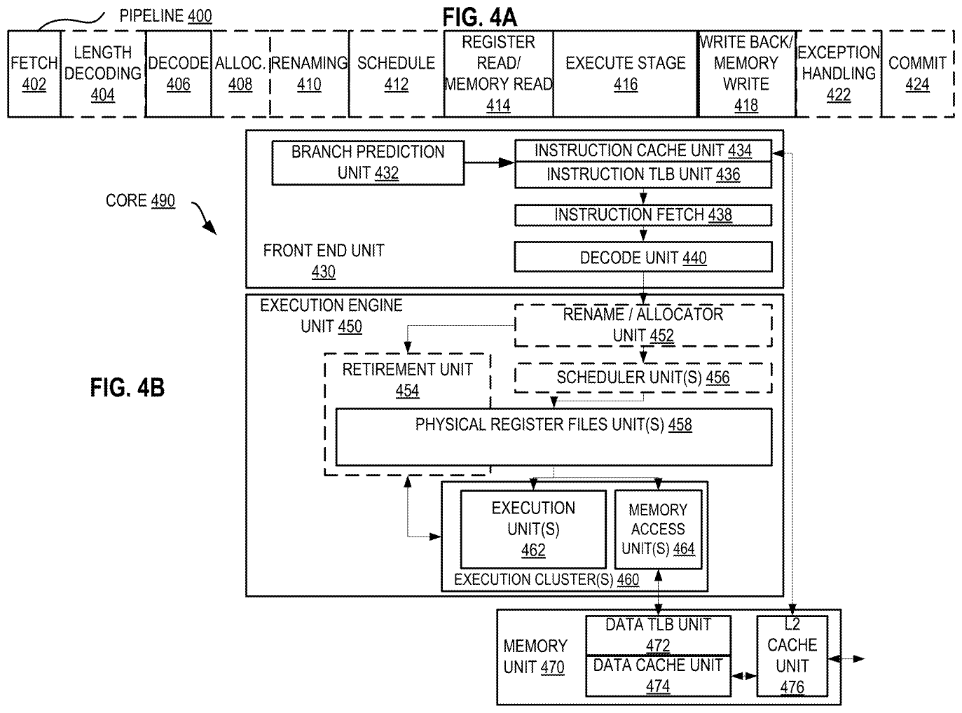

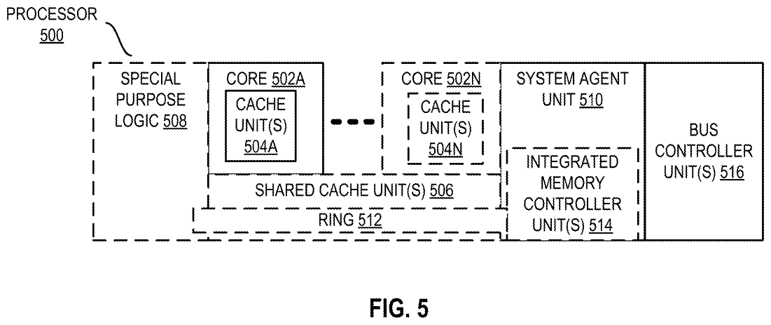

In FIG. 1A, each of CPU cores 102 and 104 represent any one or more processor or execution cores supporting a particular (e.g., x86) instruction set (with or without any combination of extensions, i.e., each core within blocks 102 and/or 104 may be identical to one or more other core or different but compatible). For example, each of CPU cores 102 and 104 may represent a single-core or multi-core Intel Atom® processor, include any combination of Intel performance cores (P-cores) and Intel efficient cores (E-cores), and/or correspond in part or in whole to core 490 in FIG. 4B, processor 500 in FIG. 5, any of processors 610-615 and co-processor 645 in FIG. 6, any of processors/co-processors 770, 780, 715, and 738 in FIG. 7, any of processor 770 or 780 in FIG. 8, and application processor 910 and co-processor 920 in FIG. 9.

Network-on chip (NoC) fabric 114 may represent an NoC or interconnect fabric (e.g., NetSpeed Systems NoC) to which cores, IP blocks, and other units may be connected and through which cores, IP blocks, and other units may be connected to each other. Cores, IP blocks, and other units may be connected to NoC fabric 114 through proprietary or custom interconnect or fabric (e.g., an in-die interconnect (IDI)) interfaces or ports or through open-standard or industry-standard interconnect or fabric (e.g., AMBA (which may include AMBA High-performance Bus (AHB), Advanced Peripheral Bus (APB), Advanced eXtensible Interface (AXI), AXI Coherency Extensions (ACE), and/or Coherent Hub Interface (CHI)) interfaces or ports. For example, NoC fabric 114 may include or support any number of IDI ports and any number of AHB, APB, AXI, ACE, and/or CHI ports. Each of CPU cores 102 and 104 may be connected to NoC fabric 114 through a corresponding IDI port.

In embodiments, each port (or network interface (NI)) provided for connecting to NoC fabric 114 may support one of a proprietary or custom (e.g., IDI) interface protocol and an open-standard or industry-standard (e.g., AMBA, AXI, etc.) interface protocol. NoC fabric 114 may include any number of interconnected or linked (in any topology) routers (or switches) to which a port may be connected. Each port may send and receive transactions or messages to and from a corresponding core, IP block, or other unit according to its interface protocol (proprietary/custom or open-standard/industry-standard) and send and receive transactions or packets to and from a corresponding router according to the NoC packet protocol. As such, each port may include or have access to circuitry/logic (e.g., within or accessible by a packet generator or maker and a packet receiver or disassembler) to perform protocol conversions or translations between its interface messaging protocol (proprietary/custom or open-standard/industry-standard) and the NoC packet protocol. Thus, any core, IP block, or other unit connected to an NoC fabric port, whether proprietary/custom or open-standard/industry-standard, may communicate with any other core, IP block, or other unit connected to an NoC fabric port.

Non-coherent unit (NCU) 132 represents a unit to handle and/or provide legacy (e.g., for backward compatibility) ISA-specific (e.g., x86) system functionality such as bus lock, local interrupts and events, and/or semaphores and registers. NCU 132 may be connected to NoC fabric 114 through an IDI port and to sideband (SB, e.g., Intel On-chip System Fabric (IOSF) SB) router 128 to provide for sideband and/or other communication between cores, IP blocks, other units, etc. connected to NoC fabric 114 and IP blocks, other units, etc. connected to SB router 128.

Interrupt and timer unit (ITU) 130 represents a unit to handle input/output (I/O) interrupts and provide timer functionality and/or include interrupt controllers and/or timers (e.g., I/O advanced programmable interrupt controller (IOAPIC), high precision event timer (HPET), programmable interval timer (8254), programmable interrupt controller (8259), etc.)

Reset, power, and clock control (PMCCK) unit 134 represents a unit to control reset, power, and clocking, for example by dividing incoming clocks to generate a set of clocks for CPU cores 102 and 104, NoC fabric 114, NCU 132, SB router 128, etc. bringing cores, IP blocks, and other units out of reset. In embodiments, the CPU reset sequence may be based on an Intel Atom® soft IP reset sequence without any power management unit.

To facilitate the use and/or addition of IP blocks from a customer or other third-party, subsystem 100 may include, support, or be designed with any combination of the following features. The power management may be simplified compared to an IC, SoC, or system not designed to accommodate customer IP blocks, for example, a proprietary power management unit (P-unit) may be optional and/or replaced by power management done autonomously by the CPU cores. The CPU reset sequence may be simplified compared to an IC, SoC, or system not designed to accommodate customer IP blocks, for example, reset may be handled by PMCCK unit 134, with the reset target triggered by one signal to PMCCK unit 134 and PMCCK 134 bringing all IP blocks out of reset before bringing the CPU cores out of reset. The legacy IP blocks may be reduced, for example, there may be no Intel legacy unit, no security unit, no Peripheral Component Interconnect (PCI) root port, and no P-unit required and any or any combination may be optionally integrated by a customer or other third-party. Programmability may be provided using fuses, which may be disabled by default.

FIG. 1B is a block diagram of bootable subsystem design 150 according to embodiments. Subsystem design 150 may represent the design (e.g., RTL) or description (e.g., HDL) of a subsystem, stored on a machine-readable medium such that it may be provided to a customer or other third-party as a basis for designing an SoC and/or for integrating into or otherwise including in an integrated circuit (IC), electronic system, or other product, such as system 600 in FIG. 6, system 700 in FIG. 7, system 800 in FIG. 8, or SoC 900 in FIG. 9. Alternatively, subsystem design 150 as shown in FIG. 1B may represent a subsystem as implemented, fabricated, etc. in hardware (e.g., logic gates memory cells, and/or other circuitry), or in any other physical or tangible form, whether as part of a system or otherwise. Therefore, the following descriptions of blocks shown in the block diagram may correspond to designs (e.g., RTL), descriptions (e.g., HDL), circuitry, etc. of such blocks, and subsystem design 150 may be referred to and/or represent a particular ISA (e.g., x86) based subsystem design, a particular ISA (e.g., x86) based subsystem, a subsystem design, a subsystem, and/or a bootable or operating system (OS) bootable subsystem or subsystem design.

To facilitate the use and/or addition of IP blocks from a customer or other third-party, subsystem 140 may include, support, or be designed with any combination of blocks and/or features as shown in or described in connection with FIG. 1, plus blocks and/or features to provide for bootability of subsystem design 140, for example, to provide for subsystem design 200 to be bootable into a Basic Input/Output System (BIOS), a Unified Extensible Firmware Interface (UEFI), and/or a Linux kernel or OS so that it and/or a system design based on it may be tested in a pre-silicon environment, execute validation tools, be prototyped (e.g., environmental and/or functional testing) with field-programmable gate arrays (FPGAs), etc.

Subsystem 140 may include system controller (SysController) 126 to convert IDI transactions or messages to sideband (e.g., IOSF-SB) transactions or messages, serial peripheral interface (SPI) 118 to provide access to a BIOS image, and universal asynchronous receiver-transmitter (UART) 120 to provide for display of BIOS and OS printouts. Each of SysController 126, SPI 118, and UART 120 may be connected to NoC fabric 114 through a corresponding AXI port.

In embodiments, NoC fabric 114 may include or support any number of sideband (e.g., IOSF-SB) ports such that SB router 128 and/or other sideband device may be connected directly to NoC fabric 114 instead of through SysController 126 (in which case the embodiment might not include SysController 126). In embodiments, each such port (or network interface (NI)) provided for connecting to NoC fabric 114 may support the sideband (e.g., IOSF-SB) protocol (e.g., may send and receive transactions or messages to and from a sideband device according to the sideband protocol), and each such port may be connected to any number of interconnected or linked (in any topology) routers (or switches) in NoC fabric 114 to send and receive transactions or packets to and from the corresponding router according to the NoC packet protocol. As such, each such sideband port may include or have access to circuitry/logic (e.g., within or accessible by a packet generator or maker and a packet receiver or disassembler) to perform protocol conversions or translations between its interface messaging protocol and the NoC packet protocol. Thus, any sideband device connected to an NoC fabric port may communicate with any core, IP block, or other unit connected to an NoC fabric port (whether connected through a proprietary or custom (e.g., IDI) port or an open-standard or industry-standard (e.g., AMBA, AXI, etc.) port.

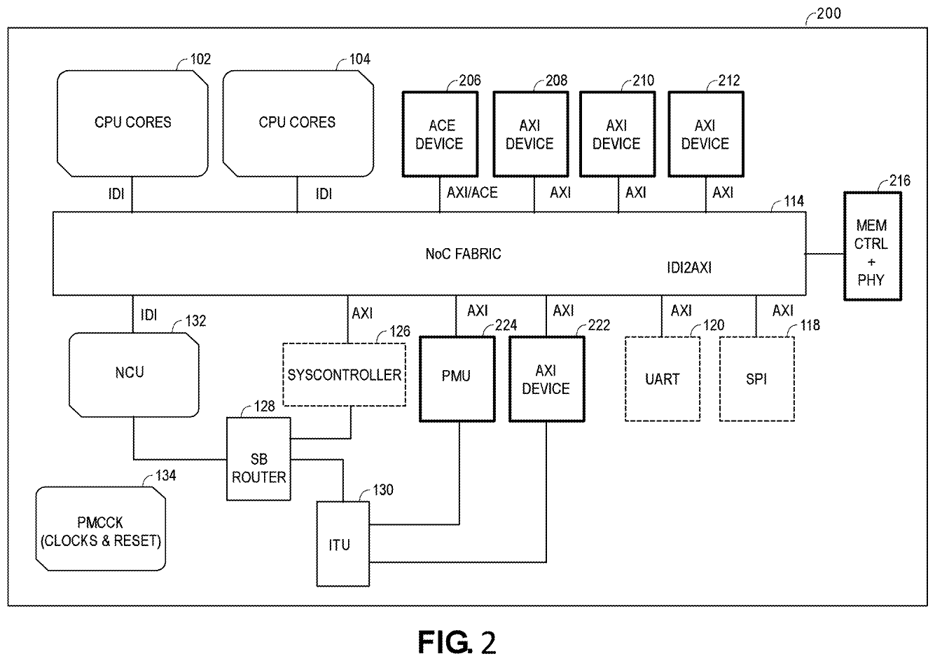

FIG. 2 is a diagram of system-on-chip (SoC) design 200 according to embodiments. SoC design 200 may represent the design (e.g., RTL) or description (e.g., HDL) of a subsystem, stored on a machine-readable medium such that it may fabricated into or included in an integrated circuit (IC), electronic system, or other product, such as system 600 in FIG. 6, system 700 in FIG. 7, system 800 in FIG. 8, or SoC 900 in FIG. 9. Alternatively, SoC design 200 as shown in FIG. 2 may represent a system as implemented, fabricated, etc. in hardware (e.g., logic gates memory cells, and/or other circuitry), or in any other physical or tangible form, whether as a system, in part or in whole, or otherwise. Therefore, the following descriptions of blocks shown in the block diagram may correspond to designs (e.g., RTL), descriptions (e.g., HDL), circuitry, etc. of such blocks, and SoC design 200 may be referred to and/or represent a particular ISA (e.g., x86) based SoC design, a particular ISA (e.g., x86) based SoC, an SoC design, an SoC, an particular ISA (x86) based system, and/or a system.

To facilitate the use and/or addition of IP blocks from a customer or other third-party, SoC 200 may include, support, or be designed with any combination of blocks and/or features as shown in or described in connection with FIGS. 1A and/or 1B, including any number of open-standard (e.g., AHB, APB, AXI, ACE, and/or CHI) interfaces or ports to which IP blocks may be connected to NoC fabric 114. Therefore, SoC 200 may include any number of customer or other third-party IP blocks, represented as ACE device 206, AXI devices 208, 210, 212, and 222, and power management unit (PMU) 224, each of which may be connected to NoC fabric 114 through a corresponding open-standard NoC or interconnect (e.g., shown as AXI and AXI/ACE) port.

SoC 200 may also include a memory (e.g., double date rate (DDR) synchronous dynamic random-access memory (SDRAM)) controller and physical layer (MEM CTRL+PHY) 218, which may be also provided by a customer or other third-party.

A design (e.g., an RTL or HDL design) according to embodiments (e.g., FIG. 1A, 1B, or 2) may be implemented by instructions and/or data that represent logic, circuitry, hardware, etc. within an IC, processor, SoC, or other product and which when read by a machine causes the machine and/or may be used by the machine to fabricate logic, circuitry, hardware, etc. according to the design. Such designs may be stored on a tangible, machine readable medium and supplied to various customers or manufacturing facilities to load into the fabrication machines that actually make the logic, circuitry, IC, processor, SoC, etc.

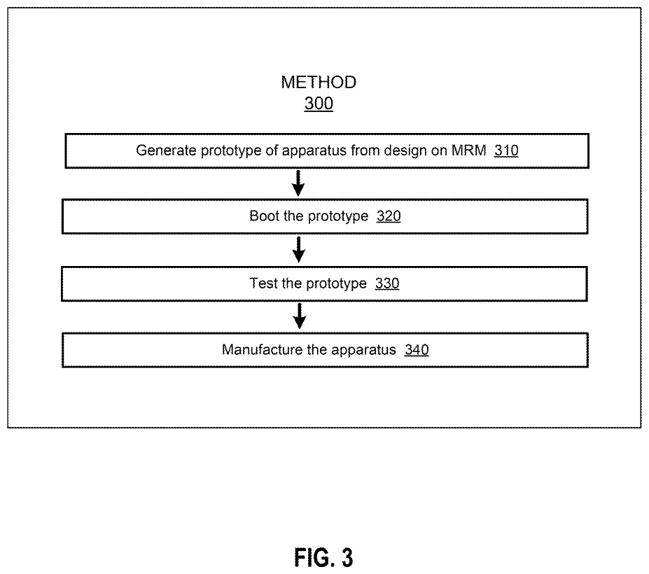

FIG. 3 is a flow diagram of method 300 for testing an SoC design according to embodiments. Method 300 starts in block 310, which represents generating, from a design stored on a machine-readable medium, a prototype of the design for an apparatus, the apparatus including one or more cores and a network-on-chip (NoC) having at least one port of a first type and at least one port of a second type, wherein the first type is to communicate with the one or more cores according to a proprietary protocol and the second type is to communicate with an intellectual property (IP) block according to an open-standard protocol. Block 320 represents booting the prototype. Block 330 represents testing the prototype. Block 340 represents manufacturing (e.g., taping-out and fabricating on silicon or other semiconductor substrate) the apparatus (e.g., an IC or SoC) from the design. In embodiments, at least one of the one or more cores is an x86 core. In embodiments, the open-standard protocol is an AMBA protocol.

### Example Embodiments

In embodiments, a machine-readable medium includes a design of an apparatus to be manufactured, the apparatus to include one or more cores, and an NoC having at least one port of a first type and at least one port of a second type. The first type is to communicate with the one or more cores according to a proprietary protocol. The second type is to communicate with an IP block according to an open-standard protocol.

Any such embodiments may include any or any combination of the following aspects. At least one of the one or more cores may be an x86 core. The open-standard protocol may be an AMBA protocol. At least one port of the first type may include circuitry to convert between messages according to the proprietary protocol and packets according to a packet protocol of the NoC. At least one port of the second type may include circuitry to convert between messages according to the open-source protocol and packets according to the packet protocol of the NoC. The apparatus may also include a non-coherent unit connected to a port of the first type to handle ISA-specific (e.g., x86) system functionality. The apparatus may also include an interrupt unit of the first type to handle interrupts. The apparatus may also include a timer unit to provide timer functionality. The apparatus may also include a reset unit to control reset of the one or more cores. The apparatus may also include a system controller to convert messages between the proprietary protocol and a sideband protocol. The apparatus may also include an interface, and a prototype of the design may be to include a representation of the interface, and the prototype may be bootable from a basic input/output system (BIOS) connected to the prototype through the representation of the interface. The apparatus may also include the IP block. The apparatus may also include a power management unit connected to a port of the second type. The design may be RTL or HDL.

In embodiments, an apparatus includes one or more cores, and IP block, and an NoC having at least one port of a first type and at least one port of a second type. The first type is to communicate with the one or more cores according to a proprietary protocol. The second type is to communicate with the IP block according to an open-standard protocol.

Any such embodiments may include any or any combination of the following aspects. At least one of the one or more cores may be an x86 core. The open-standard protocol may be an AMBA protocol. At least one port of the first type may include circuitry to convert between messages according to the proprietary protocol and packets according to a packet protocol of the NoC. At least one port of the second type may include circuitry to convert between messages according to the open-source protocol and packets according to the packet protocol of the NoC. The apparatus may also include a non-coherent unit connected to a port of the first type to handle ISA-specific (e.g., x86) system functionality. The apparatus may also include an interrupt unit of the first type to handle interrupts. The apparatus may also include a timer unit to provide timer functionality. The apparatus may also include a reset unit to control reset of the one or more cores. The apparatus may also include a system controller to convert messages between the proprietary protocol and a sideband protocol. The apparatus may also include an interface, and a prototype of the design may be to include a representation of the interface, and the prototype may be bootable from a basic input/output system (BIOS) connected to the prototype through the representation of the interface. The apparatus may also include the IP block. The apparatus may also include a power management unit connected to a port of the second type.

In embodiments, a method includes generating, from a design stored on a machine-readable medium, a prototype of the design for an apparatus, the apparatus including one or more cores and an NoC having at least one port of a first type and at least one port of a second type, wherein the first type is to communicate with the one or more cores according to a proprietary protocol and the second type is to communicate with an IP block according to an open-standard protocol; booting the prototype; and testing the prototype.

Any such embodiments may include any or any combination of the following aspects. The method may include manufacturing the apparatus from the design. At least one of the one or more cores may be an x86 core. The open-standard protocol may be an AMBA protocol. At least one port of the first type may include circuitry to convert between messages according to the proprietary protocol and packets according to a packet protocol of the NoC. At least one port of the second type may include circuitry to convert between messages according to the open-source protocol and packets according to the packet protocol of the NoC. The apparatus may also include a non-coherent unit connected to a port of the first type to handle ISA-specific (e.g., x86) system functionality. The apparatus may also include an interrupt unit of the first type to handle interrupts. The apparatus may also include a timer unit to provide timer functionality. The apparatus may also include a reset unit to control reset of the one or more cores. The apparatus may also include a system controller to convert messages between the proprietary protocol and a sideband protocol. The apparatus may also include an interface, and a prototype of the design may be to include a representation of the interface, and the prototype may be bootable from a basic input/output system (BIOS) connected to the prototype through the representation of the interface. The apparatus may also include the IP block. The apparatus may also include a power management unit connected to a port of the second type. The design may be RTL or HDL.

In embodiments, an apparatus may include means for performing any function disclosed herein. In embodiments, an apparatus may include a data storage device that stores code that when executed by a hardware processor or controller causes the hardware processor or controller to perform any method or portion of a method disclosed herein. In embodiments, an apparatus may be as described in the detailed description. In embodiments, a method may be as described in the detailed description. In embodiments, a non-transitory machine-readable medium may store instructions that when executed by a machine causes the machine to perform any method or portion of a method disclosed herein. Embodiments may include any details, features, etc. or combinations of details, features, etc. described in this specification.

### Example Core Architectures, Processors, and Computer Architectures

The following description and associated figures detail example architectures and systems to implement embodiments of the above.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

### Example Core Architectures

### In-Order and Out-of-Order Core Block Diagram

FIG. 4A is a block diagram illustrating both an example in-order pipeline and an example register renaming, out-of-order issue/execution pipeline according to embodiments. FIG. 4B is a block diagram illustrating both an example embodiment of an in-order architecture core and an example register renaming, out-of-order issue/execution architecture core to be included in a processor according to embodiments. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front-end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front-end unit 430 includes a branch prediction unit 432, which is coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front-end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a write mask registers unit, and a scalar registers unit. These register units may provide architectural vector registers, vector mask registers, and general-purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register map and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one example embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the example register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5 is a block diagram of a processor 500 that may have more than one core, may have an integrated memory controller, and may have integrated graphics according to embodiments. The solid lined boxes in FIG. 5 illustrate a processor 500 with a single core 502A, a system agent 510, a set of one or more bus controller units 516, while the optional addition of the dashed lined boxes illustrates an alternative processor 500 with multiple cores 502A-N, a set of one or more integrated memory controller unit(s) 514 in the system agent unit 510, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 506, and external memory (not shown) coupled to the set of integrated memory controller units 514. The set of shared cache units 506 may include one or more mid-level caches, such as level 2 (L2), level 3 (L3), level 4 (L4), or other levels of cache, a last level cache (LLC), and/or combinations thereof. While in one embodiment a ring-based interconnect unit 512 interconnects the integrated graphics logic 508 (integrated graphics logic 508 is an example of and is also referred to herein as special purpose logic), the set of shared cache units 506, and the system agent unit 510/integrated memory controller unit(s) 514, alternative embodiments may use any number of well-known techniques for interconnecting such units. In one embodiment, coherency is maintained between one or more cache units 506 and cores 502A-N.

In some embodiments, one or more of the cores 502A-N are capable of multi-threading. The system agent 510 includes those components coordinating and operating cores 502A-N. The system agent unit 510 may include for example a power control unit (PCU) and a display unit. The PCU may be or include logic and components needed for regulating the power state of the cores 502A-N and the integrated graphics logic 508. The display unit is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set.

### Example Computer Architectures

FIGS. 6-9 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a system 600 in accordance with one embodiment. The system 600 may include one or more processors 610, 615, which are coupled to a controller hub 620. In one embodiment, the controller hub 620 includes a graphics memory controller hub (GMCH) 690 and an Input/Output Hub (IOH) 650 (which may be on separate chips); the GMCH 690 includes memory and graphics controllers to which are coupled memory 640 and a coprocessor 645; the IOH 650 couples input/output (I/O) devices 660 to the GMCH 690. Alternatively, one or both of the memory and graphics controllers are integrated within the processor (as described herein), the memory 640 and the coprocessor 645 are coupled directly to the processor 610, and the controller hub 620 in a single chip with the IOH 650.

The optional nature of additional processors 615 is denoted in FIG. 6 with broken lines. Each processor 610, 615 may include one or more of the processing cores described herein and may be some version of the processor 500.

The memory 640 may be, for example, dynamic random-access memory (DRAM), phase change memory (PCM), or a combination of the two. For at least one embodiment, the controller hub 620 communicates with the processor(s) 610, 615 via a multi-drop bus, such as a frontside bus (FSB), point-to-point interface such as QuickPath Interconnect (QPI), or similar connection 695.

In one embodiment, the coprocessor 645 is a special-purpose processor, such as, for example, a high-throughput MIC processor, a network or communication processor, compression engine, graphics processor, GPGPU, embedded processor, or the like. In one embodiment, controller hub 620 may include an integrated graphics accelerator.

There can be a variety of differences between the physical resources 610, 615 in terms of a spectrum of metrics of merit including architectural, microarchitectural, thermal, power consumption characteristics, and the like.

In one embodiment, the processor 610 executes instructions that control data processing operations of a general type. Embedded within the instructions may be coprocessor instructions. The processor 610 recognizes these coprocessor instructions as being of a type that should be executed by the attached coprocessor 645. Accordingly, the processor 610 issues these coprocessor instructions (or control signals representing coprocessor instructions) on a coprocessor bus or other interconnect, to coprocessor 645. Coprocessor(s) 645 accept and execute the received coprocessor instructions.

Referring now to FIG. 7, shown is a block diagram of a first more specific example system 700 in accordance with an embodiment. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 500. In one embodiment, processors 770 and 780 are respectively processors 610 and 615, while coprocessor 738 is coprocessor 645. In another embodiment, processors 770 and 780 are respectively processor 610 and coprocessor 645.

Processors 770 and 780 are shown including integrated memory controller (IMC) units 772 and 782, respectively. Processor 770 also includes as part of its bus controller unit's point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may optionally exchange information with the coprocessor 738 via a high-performance interface 792. In one embodiment, the coprocessor 738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope is not so limited.

As shown in FIG. 7, various I/O devices 714 may be coupled to first bus 716, along with a bus bridge 718 which couples first bus 716 to a second bus 720. In one embodiment, one or more additional processor(s) 715, such as coprocessors, high-throughput MIC processors, GPGPU's, accelerators (such as, e.g., graphics accelerators or digital signal processing (DSP) units), field programmable gate arrays, or any other processor, are coupled to first bus 716. In one embodiment, second bus 720 may be a low pin count (LPC) bus. Various devices may be coupled to a second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to the second bus 720. Note that other architectures are possible. For example, instead of the point-to-point architecture of FIG. 7, a system may implement a multi-drop bus or other such architecture.

Referring now to FIG. 8, shown is a block diagram of a second more specific example system 800 in accordance with an embodiment. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. Thus, the CL 772, 782 include integrated memory controller units and include I/O control logic. FIG. 8 illustrates that not only are the memories 732, 734 coupled to the CL 772, 782, but also that I/O devices 814 are also coupled to the control logic 772, 782. Legacy I/O devices 815 are coupled to the chipset 790.

Referring now to FIG. 9, shown is a block diagram of a SoC 900 in accordance with an embodiment. Similar elements in FIG. 5 bear like reference numerals. Also, dashed lined boxes are optional features on more advanced SoCs. In FIG. 9, an interconnect unit(s) 902 is coupled to: an application processor 910 which includes a set of one or more cores 502A-N, which include cache units 504A-N, and shared cache unit(s) 506; a system agent unit 510; a bus controller unit(s) 516; an integrated memory controller unit(s) 514; a set or one or more coprocessors 920 which may include integrated graphics logic, an image processor, an audio processor, and a video processor; an static random access memory (SRAM) unit 930; a direct memory access (DMA) unit 932; and a display unit 940 for coupling to one or more external displays. In one embodiment, the coprocessor(s) 920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments may be implemented as computer programs or program code executing on programmable systems comprising at least one processor, a storage system (including volatile and non-volatile memory and/or storage elements), at least one input device, and at least one output device.

Program code, such as code 730 illustrated in FIG. 7, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments also include non-transitory, tangible machine-readable media containing instructions or containing design data, such as Hardware Description Language (HDL), which defines structures, circuits, apparatuses, processors and/or system features described herein. Such embodiments may also be referred to as program products.

In this specification, operations in flow diagrams may have been described with reference to example embodiments of other figures. However, it should be understood that the operations of the flow diagrams may be performed by embodiments other than those discussed with reference to other figures, and the embodiments discussed with reference to other figures may perform operations different than those discussed with reference to flow diagrams. Furthermore, while the flow diagrams in the figures show a particular order of operations performed by certain embodiments, it should be understood that such order is provided as an example (e.g., alternative embodiments may perform the operations in a different order, combine certain operations, overlap certain operations, etc.).

While several embodiments have been described, those skilled in the art will recognize that these descriptions are limiting, and embodiments can be practiced with modification and alteration within the spirit and scope of the appended claims. The description is thus to be regarded as illustrative instead of limiting.

What is claimed is:

1. A machine-readable medium (MRM) comprising:
a design of an apparatus to be manufactured, the apparatus to include:
one or more cores, and
a network-on-chip (NoC) having at least one port of a first type and at least one port of a second type, wherein the first type is to communicate with the one or more cores according to a proprietary protocol and the second type is to communicate with an intellectual property (IP) block according to an open-standard protocol.

2. The MRM of claim 1, wherein at least one of the one or more cores is an x86 core.

3. The MRM of claim 1, wherein the open-standard protocol is an Advanced Microcontroller Bus Architecture (AMBA) protocol.

4. The MRM of claim 1, wherein the at least one port of the first type includes circuitry to convert between messages according to the proprietary protocol and packets according to a packet protocol of the NoC.

5. The MRM of claim 4, wherein the at least one port of the second type includes circuitry to convert between messages according to the open-source protocol and packets according to the packet protocol of the NoC.

6. The MRM of claim 5, wherein the apparatus further comprises a non-coherent unit connected to a port of the first type to handle x86-specific system functionality.

7. The MRM of claim 5, wherein the apparatus further comprises an interrupt and timer unit to handle interrupts and provide timer functionality.

8. The MRM of claim 1, wherein the design is a register transfer level design or is in a hardware description language.

9. The MRM of claim 5, wherein the apparatus further comprises a reset unit to control reset of the one or more cores.

10. The MRM of claim 5, wherein the apparatus further comprises a system controller to convert messages between the proprietary protocol and a sideband protocol.

11. The MRM of claim 5, wherein the apparatus further comprises an interface, and wherein a prototype of the design is to include a representation of the interface, and wherein the prototype is to be bootable from a basic input/output system (BIOS) connected to the prototype through the representation of the interface.

12. The MRM of claim 5, wherein the apparatus further comprises the IP block.

13. The MRM of claim 5, wherein the apparatus further comprises a power management unit connected to a port of the second type.

14. An apparatus comprising:
one or more cores;
an IP block; and
a network-on-chip (NoC) having at least one port of a first type and at least one port of a second type, wherein the first type is to communicate with the one or more cores according to a proprietary protocol and the second type is to communicate with the intellectual property (IP) block according to an open-standard protocol.

15. The apparatus of claim 14, wherein at least one of the one or more cores is an x86 core.

16. The apparatus of claim 14, wherein the open-standard protocol is an Advanced Microcontroller Bus Architecture (AMBA) protocol.

17. The apparatus of claim 14, wherein the at least one port of the first type includes circuitry to convert between messages according to the proprietary protocol and packets according to a packet protocol of the NoC.

18. The apparatus of claim 17, wherein the at least one port of the second type includes circuitry to convert between messages according to the open-source protocol and packets according to the packet protocol of the NoC.

19. A method comprising:
generating, from a design stored on a machine-readable medium, a prototype of the design for an apparatus, the apparatus including one or more cores and a network-on-chip (NoC) having at least one port of a first type and at least one port of a second type, wherein the first type is to communicate with the one or more cores according to a proprietary protocol and the second type is to communicate with an intellectual property (IP) block according to an open-standard protocol;
booting the prototype; and
testing the prototype.

20. The method of claim 19, further comprising manufacturing the apparatus from the design.
